(19) United States
(12) Patent Application Publication
(10) Pub. No.: US 2019/0146208 A1
(43) Pub. Date: May 16, 2019

(54) ROTARY DRIVE APPARATUS

(71) Applicant: Nidec Corporation, Kyoto (JP)

(72) Inventor: Junya MIZUKAMI, Kyoto (JP)

(21) Appl. No.: 16/147,909

(22) Filed: Oct. 1, 2018

(30) Foreign Application Priority Data
Nov. 10, 2017 (JP) 2017-216924
Mar. 27, 2018 (JP) 2018-059578

(51) Int. Cl. G02B 26/08; H02K 7/02

(52) U.S. Cl. CPC G02B 26/0816; H02K 7/02

(57) ABSTRACT

A rotary drive apparatus that rotates while reflecting light emitted from a light source includes a motor, a flywheel supported by a rotating portion of the motor, and a plate-shaped mirror. The mirror is fixed to the flywheel with adhesives located at corner portions of the mirror and spaced apart from one another along end sides of the mirror. Thus, the mirror is fixed to the flywheel with the adhesives, and distortion of the mirror due to curing of the adhesives is reduced or prevented.

### CROSS REFERENCE TO RELATED APPLICATIONS

This application claims the benefit of priority to Japanese Patent Application No. 2017-216924 filed on Nov. 10, 2017 and Japanese Patent Application No. 2018-059578 filed on Mar. 27, 2018. The entire contents of this application are hereby incorporated herein by reference.

### BACKGROUND OF THE INVENTION

### 1. Field of the Invention

The present invention relates to a rotary drive apparatus.

### 2. Description of the Related Art

Conventionally, various devices including optical components have been known. For example, JP 2010-021105 A discloses an optical device including a light guide member 4, and a rod base 3 that supports the light guide member 4. In this publication, illumination light emitted from an LED is reflected by a reflection prism of the light guide member 4. In addition, the rod base 3 has a roughened contact surface that supports the light guide member 4.

In JP 2010-021105 A, no adhesive is used for fixing the light guide member 4 to the rod base 3.

On the other hand, in recent years, there is an increasing demand for a rotary drive apparatus arranged to rotate a mirror, as an apparatus for use in, for example, optical position recognition in a three-dimensional space. In a rotary drive apparatus of this type, it is necessary to firmly fix a mirror with an adhesive in order to prevent positional displacement or separation of the mirror due to centrifugal force. However, the use of an adhesive results in slight distortion of a mirror due to stress to be generated when the adhesive is cured. This distortion may change an orientation of reflected light.

### SUMMARY OF THE INVENTION

Preferred embodiments of the present invention provide rotary drive apparatuses each including a structure capable of fixing a mirror with an adhesive and suppressing distortion of the mirror due to curing of the adhesive.

A preferred embodiment of the present invention provides a rotary drive apparatus that rotates while reflecting light emitted from a light source, the rotary drive apparatus including a motor including a rotating portion rotatable about a central axis extending in a vertical direction; a flywheel supported by the rotating portion; a mirror including a plurality of corner portions and a plurality of end sides, and having a plate shape; and a plurality of adhesives that fix the mirror to the flywheel, wherein the adhesives are located at the corner portions of the mirror and are spaced apart from one another along the end sides of the mirror.

According to preferred embodiments of the present invention, it is possible to fix a mirror to a flywheel with an adhesive and to suppress distortion of the mirror due to curing of the adhesive.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a rotary drive apparatus, a light source, and a housing.

FIG. 2 is a vertical sectional view of the rotary drive apparatus.

FIG. 3 is a perspective view of the mirror.

FIG. 4 is a perspective view of a flywheel and the mirror.

FIG. 5 is a graph illustrating a relationship between an applied position of an adhesive to the mirror and an amount of deformation of reflected light which is reflected by the mirror.

FIG. 6 illustrates how to fix the mirror in a mirror accommodating portion.

FIG. 7 is a perspective view of a mirror according to a modification.

### DETAILED DESCRIPTION OF THE PREFERRED EMBODIMENTS

Hereinafter, preferred embodiments of the present invention will be described with reference to the accompanying drawings. It is assumed herein that a direction parallel with a central axis of a motor which will be described later is referred to simply by the term “axial direction”, “axial”, or “axially”, that directions perpendicular to the central axis of the motor are each referred to simply by the term “radial direction”, “radial”, or “radially”, and that a direction along a circular arc centered on the central axis of the motor is referred to simply by the term “circumferential direction”, “circumferential”, or “circumferentially”. The shape of each member or portion and relative positions of different members or portions will be described on the assumption that an axial direction is a vertical direction and a light source side relative to a motor is an upper side. It should be noted, however, that the above definition of the vertical direction and the upper and lower sides is not meant to restrict in any way the orientation of a rotary drive apparatus according to any preferred embodiment of the present invention when in use. It also should be noted that a wording “a direction parallel with” as used herein includes “a direction substantially parallel with”. It also should be noted that a wording “a direction perpendicular to” as used herein includes “a direction substantially perpendicular to”.

### 1. Structure of Rotary Drive Apparatus

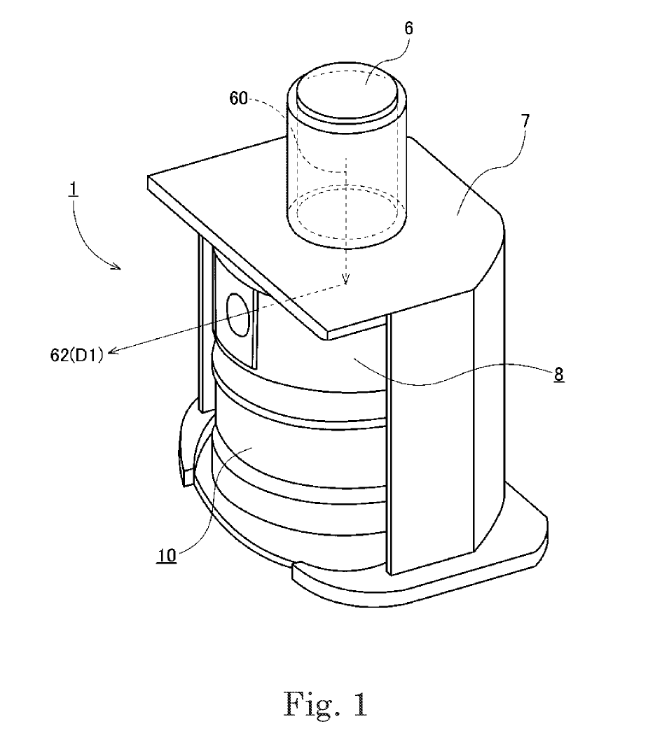

FIG. 1 is a perspective view of a rotary drive apparatus 1, a light source 6, and a housing 7 according to a preferred embodiment. The rotary drive apparatus 1 is an apparatus arranged to rotate while reflecting incoming light 60 coming from the light source 6 in a radial direction (i.e., a first radial direction D1) and to emit the reflected light 62 out of the rotary drive apparatus 1. The light source 6 installed in the housing 7 is mounted above the rotary drive apparatus 1. An optical axis of the light source 6 is defined on a central axis 9 of a motor 10 which will be described later. The housing 7 is fixed to a casing in which the rotary drive apparatus 1 is arranged. The light source 6 is arranged to emit the incoming light 60 which travels downward along the central axis 9. In the preferred embodiment, each of the light source 6 and the housing 7 is arranged outside of the rotary drive apparatus 1. Alternatively, each of the light source 6 and the housing 7 may be included in the rotary drive apparatus 1.

The rotary drive apparatus 1 includes the motor 10, a flywheel 8, a mirror 61 which will be described later, a lens 63 which will be described later, and an adhesive 100 which will be described later.

### 2. Structure of Motor

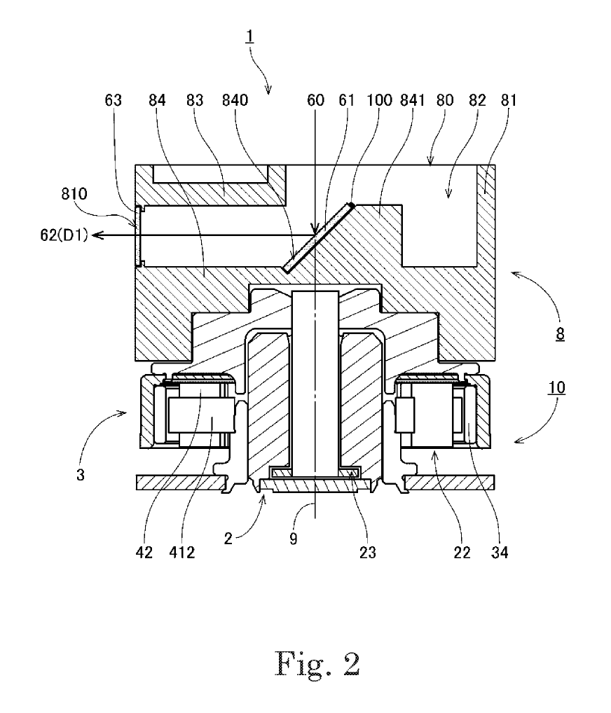

A structure of the motor 10 will be described first. FIG. 2 is a vertical sectional view of the rotary drive apparatus 1.

Referring to FIG. 2, the motor 10 includes a stationary portion 2 including a stator 22, and a rotating portion 3 including a magnet 34. The stationary portion 2 is arranged to be stationary relative to the housing 7. The rotating portion 3 is supported through a bearing portion 23 to be rotatable about the central axis 9, which extends in the vertical direction, with respect to the stationary portion 2.

Once electric drive currents are supplied to coils 42 included in the stator 22, magnetic flux is generated around each of a plurality of teeth 412, which are magnetic cores for the coils 42. Then, interaction between the magnetic flux of the teeth 412 and magnetic flux of the magnet 34 produces a circumferential torque between the stationary portion 2 and the rotating portion 3. As a result, the rotating portion 3 is caused to rotate about the central axis 9 with respect to the stationary portion 2. Thus, the flywheel 8, which is supported by the rotating portion 3, is caused to rotate about the central axis 9 together with the rotating portion 3.

As the bearing portion 23, a fluid dynamic bearing is used, for example. In the case of using a fluid dynamic bearing, the stationary portion 2 and the rotating portion 3 are arranged opposite to each other with a gap in which a lubricating oil exists therebetween. In driving the motor 10, a fluid dynamic pressure is induced in the lubricating oil. Note that a bearing of another type, such as, for example, a rolling-element bearing, may alternatively be used as the bearing portion 23.

### 3. Structures of Flywheel, Mirror, and Lens

Structures of the flywheel 8, mirror 61, and lens 63 will be described next.

The flywheel 8 is placed below the light source 6 and above the motor 10. The flywheel 8 is supported by the rotating portion 3 of the motor 10. The flywheel 8 is fixed to an upper surface of the rotating portion 3 through, for example, engagement or an adhesive. A resin, for example, is used as a material of the flywheel 8. The flywheel 8 holds each of the mirror 61 and the lens 63. The mirror 61 has a reflecting surface which will be described later. The incoming light 60 coming from the light source 6 is reflected at the reflecting surface of the mirror 61, so that the orientation thereof is changed. The lens 63 is arranged to allow the reflected light 62 reflected by the mirror 61 to pass therethrough. Glass, for example, is used as materials of the mirror 61 and the lens 63.

Referring to FIG. 2, the flywheel 8 includes a cylindrical wall portion 81, a hollow portion 82, a lens barrel portion 83, and a lower supporting portion 84. The cylindrical wall portion 81, the lens barrel portion 83, and the lower supporting portion 84 are formed as a single member by resin injection molding. Note, however, that the cylindrical wall portion 81, the lens barrel portion 83, and the lower supporting portion 84 may alternatively be defined by separate members.

The cylindrical wall portion 81 is a cylindrical portion arranged around the central axis 9. The hollow portion 82 is a cavity provided inside of the cylindrical wall portion 81. The cylindrical wall portion 81 has a through hole 810 in a portion in the circumferential direction. The through hole 810 is arranged to pass through the cylindrical wall portion 81 in the first radial direction D1. The lens 63 is fitted into the through hole 810 and is fixed to the cylindrical wall portion 81. The lens barrel portion 83 extends radially inward from a peripheral edge portion of the through hole 810 in a cylindrical shape.

The lower supporting portion 84 expands perpendicularly to the central axis 9 in a lower portion of the flywheel 8. The lower supporting portion 84 includes a mirror supporting portion 841. The mirror supporting portion 841 is arranged to project upward from an upper surface of the lower supporting portion 84. The mirror 61 is fixed to the mirror supporting portion 841.

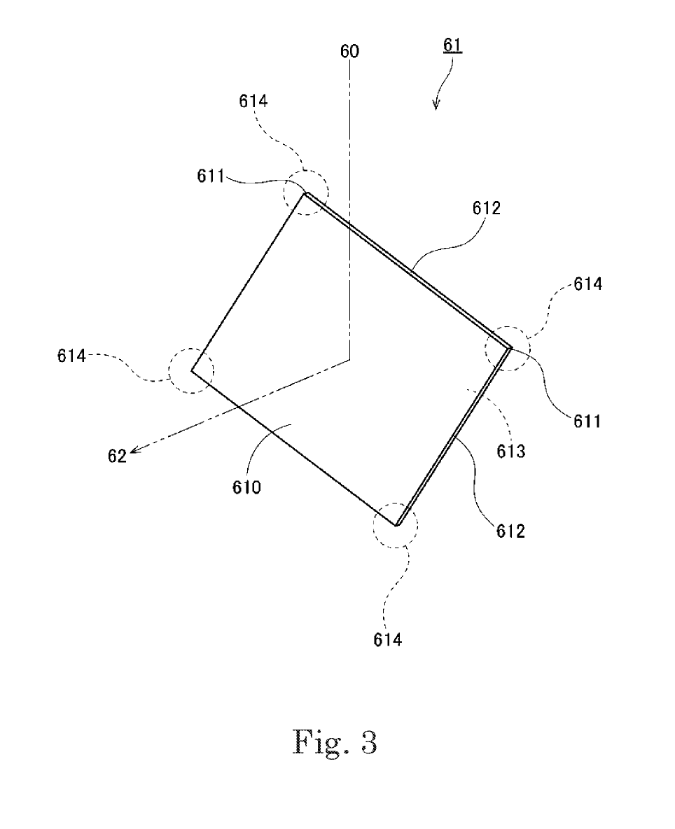

FIG. 3 is a perspective view of the mirror 61. Referring to FIG. 3, the mirror 61 according to the preferred embodiment is in the shape of a plate, and is arranged to have a rectangular external shape. The mirror 61 includes four corner portions 611 and four end sides 612. Each of the corner portions 611 is a portion corresponding to an apex of a rectangle. Each of the end sides 612 is a portion arranged to extend linearly between adjoining two of the corner portions 611. A central portion of the mirror 61 is defined on the central axis 9. A front surface 610 (reflecting surface) of the mirror 61 is inclined at an angle of 45 degrees with respect to the axial direction and the first radial direction D1. A fully reflective mirror, for example, is used as the mirror 61. The incoming light 60 impinges on the central portion of the mirror 61.

The lens 63 is arranged to have a disk plate external shape. The lens 63 is placed in the through hole 810 and is mounted at right angles to the first radial direction D1. The lens 63 is fixed to the flywheel 8 through, for example, adhesion or engagement. The mirror 61, the hollow portion 82, and the lens 63 are arranged to overlap with each other when viewed in the first radial direction D1. The reflected light 62 described above is arranged to pass through a central portion of the lens 63 and is emitted out of the flywheel 8. Note, however, that the lens 63 may be fixed to a lens frame held by the flywheel 8.

An opening 80 is formed at an upper surface of the flywheel 8. The reflecting surface of the mirror 61 is exposed from the opening 80. The incoming light 60 emitted from the light source 6 impinges on the mirror 61 through the opening 80. As described above, the incoming light 60 is reflected by the mirror to become the reflected light 62. The reflected light 62 further travels in the hollow portion 82 in the first radial direction D1, and is emitted out of the rotary drive apparatus 1 through the lens 63 fitted in the through hole 810 of the cylindrical wall portion 81.

The mirror 61 is arranged to reflect the incoming light while rotating about the central axis 9 together with the rotating portion 3 of the motor 10. Thus, the orientation of the reflected light 62 (i.e., the first radial direction D1) is rotated.

### 4. Structure to Mount Mirror to Flywheel

A structure to mount the mirror 61 to the flywheel 8 will be described next.

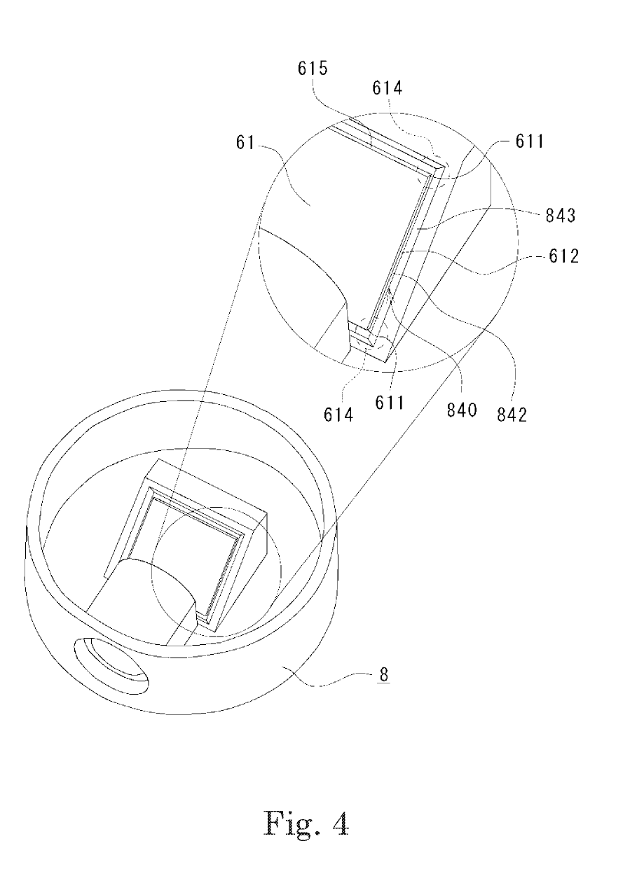

FIG. 4 is a perspective view of the flywheel 8 and the mirror 61. The mirror supporting portion 841 of the flywheel 8 includes a recessed mirror accommodating portion 840 in which the mirror 61 is fitted. A mount surface 842 which is a bottom surface of the mirror accommodating portion 840 is inclined at an angle of 45 degrees with respect to the axial direction and the first radial direction D1. The mount surface 842 is arranged to have a rectangular shape. The mount surface 842 is slightly larger in lengthwise and crosswise dimensions than a rear surface of the mirror 61.

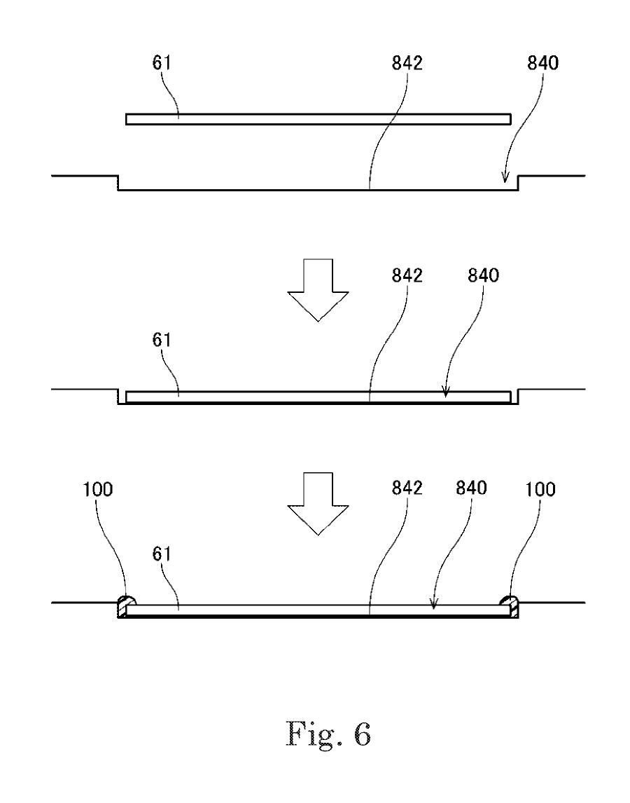

FIG. 6 illustrates how to fix the mirror 61 in the mirror accommodating portion 840. Referring to FIG. 6, in fixing the mirror 61 in the mirror accommodating portion 840, first, the mirror 61 is mounted on the mount surface 842, so that the mirror 61 is fitted in the mirror accommodating portion 840. Thus, the mirror 61 is positioned with good accuracy at a predetermined position on the flywheel 8.

Next, referring to FIGS. 3 to 6, the adhesive 100 is applied to each of the four corner portions 611 and a portion near each of the four corner portions 611 of the mirror 61 mounted in the mirror accommodating portion 840. Each of the four corner portions 611 is covered with the adhesive 100. In FIGS. 3 and 4, broken line circles indicate application regions 614 to which the adhesive 100 is applied. In each of the application regions 614, the adhesive 100 is in contact with both the corner portion 611 and the flywheel 8. Thus, the mirror 61 is fixed to the flywheel 8 with satisfactory strength. As a result, the mirror 61 is less prone to being removed from, separated from, and scattered from the flywheel 8.

The adhesive 100 according to the preferred embodiment is a resin of an ultraviolet curable type. Therefore, the adhesive 100 is cured in a shorter time as compared with a thermosetting or anaerobic adhesive. The adhesive 100 is therefore less prone to being displaced due to its fluidity until the adhesive 100 is applied and then cured. In addition, since the adhesive 100 is cured in a shorter time, the production efficiency of the rotary drive apparatus 1 can be improved.

The adhesives 100 on the four corner portions 611 of the mirror 61 are spaced apart from each other along the end sides 612 of the mirror 61. Therefore, at the time when the adhesive 100 is cured, a portion near the center of each end side 612 of the mirror 61 is less susceptible to stress from the adhesive 100. Distortion of the mirror 61 due to curing of the adhesive 100 can thus be suppressed. Note, preferably, that the adhesive 100 is applied to only a portion near each corner portion 611. Specifically, it is preferable that the adhesives 100 are in contact with regions equal to or less than half of the four end sides 612 of the mirror 61.

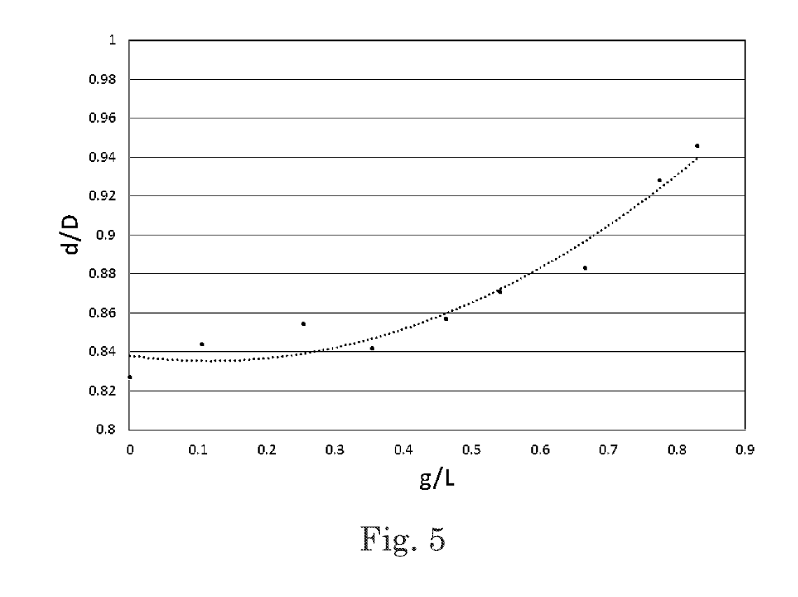

FIG. 5 illustrates a relationship between an applied position of the adhesive 100 to the mirror 61 and an amount of deformation of the reflected light 62 which is reflected by the mirror 61. The horizontal axis indicates a ratio (g/L) of an interval g between the adhesives applied to the corner portions of the end sides of the mirror 61, to a length L of each of the end sides. The vertical axis indicates a ratio (d/D) of a shorter axis d to a longer axis D of a cross-section taken along a direction perpendicular to the first radial direction D1 of the reflected light 62. Referring to FIG. 5, as the ratio g/L approaches a value of 1, the ratio d/D also approaches a value of 1. In other words, as the interval between adjoining two of the adhesives widens, a cross-section of the reflected light 62 comes close to a perfect circle. That is, the distortion of the mirror 61 can be suppressed. Therefore, when the adhesives are applied to only both ends of one end side of the mirror 61, that is, only portions near adjoining two of the corner portions 611 of the mirror 61, the interval g between adjoining two of the adhesives widens, so that the ratio g/L approaches the value of 1. Referring to FIG. 5, preferably, the ratio g/L takes a value equal to or more than 0.5, that is, the adhesive 100 is in contact with a region which is equal to or less than a half of each of the four end sides 612 of the mirror 61. The application range of the adhesive 100 is restricted as described above, so that the distortion of the mirror 61 can be further suppressed.

In the preferred embodiment, as described above, the adhesive 100 is applied after the mirror 61 is mounted on the mount surface 842 of the flywheel 8. As illustrated in FIG. 6, therefore, the corner portion 611 of the mirror 61 is sandwiched between a part of the adhesive 100 and the mount surface 842 of the flywheel 8. The mirror 61 can thus be firmly fixed to the flywheel 8. If the mirror 61 is mounted on the mount surface 842 after the adhesive 100 is applied to the mount surface 842 or the mirror 61 in advance, the adhesive 100 spreads out at the time when the mirror 61 is mounted. However, when the adhesive 100 is applied after the mirror 61 is mounted on the mount surface 842 as described in the preferred embodiment, the adhesive 100 does not spread out. The application range of the adhesive 100 can therefore be managed with ease. As a result, it is possible to suppress adhesion, drooling, scattering, and the like of the adhesive 100 to an unintended portion.

Also in the preferred embodiment, the mirror 61 is mounted in a state in which the mirror 61 is inclined at an angle of 45 degrees with respect to the central axis 9 and the first radial direction D1. Some of the adhesives 100 are in contact with corner portions 611 placed axially above the center of the mirror 61, among the four corner portions 611 of the mirror 61. Accordingly, some of the adhesives 100 are in contact with an upper end side 615 corresponding to the end side 612 placed on the axially uppermost side of the mirror 61. With this, it is possible to suppress a situation in which the adhesive 100 not cured yet is dropped by gravity to spread out to an unintended portion.

### 5. Modifications

The preferred embodiments of the present invention have been described above; however, the present invention is not limited to the above-described preferred embodiments.

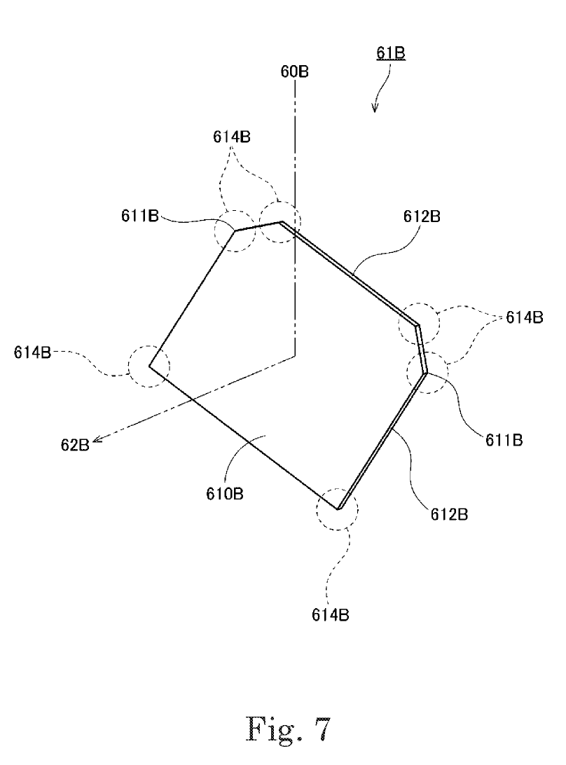

FIG. 7 is a perspective view of a mirror 61B according to a modification. The mirror 61B in FIG. 7 is in the shape of a plate, and is arranged to have a hexagonal external shape. The mirror 61B includes six corner portions 611B and six end sides 612B. The mirror 61B is mounted in the mirror accommodating portion in a state in which the mirror 61B is inclined at an angle of 45 degrees with respect to the axial direction and the first radial direction. Incoming light 60B emitted from the light source is reflected by a front surface 610B (reflecting surface) of the mirror 61B to become reflected light 62B.

In a case where the mirror 61B is fixed to the mirror accommodating portion of the flywheel, first, the mirror 61B is mounted on the mount surface of the mirror accommodating portion. Next, the adhesive is applied to each of the six corner portions 611B and a portion near each of the six corner portions 611B of the mirror 61B. Each of the six corner portions 611 is covered with the adhesive 100. In FIG. 7, broken line circles indicate application regions 614B to which the adhesive is applied. In each of the application regions 614B, the adhesive is in contact with both the corner portion 611B and the flywheel. Thus, the mirror 61B is fixed to the flywheel with satisfactory strength. As a result, the mirror 61B is less prone to being removed from, separated from, and scattered from the flywheel.

In the mirror 61B of this modification, end sides 612B more than half of the six end sides 612B are placed axially above the center of the mirror 61B. Accordingly, application regions 614B equal to or more than half of the six application regions 614B to which the adhesive is applied are placed axially above the center of the mirror 61B. With this, it is possible to suppress a situation in which the adhesive 100 not cured yet is dropped by gravity to spread out to an unintended portion. However, the number of corner portions and end sides of the mirror is not limited thereto. The mirror may include a plurality of corner portions and a plurality of end sides.

Note, however, that the adhesive is not necessarily applied to all the corner portions of the mirror.

The mirror described in the above-described embodiment is a fully reflective mirror. However, a half mirror which allows a part of incoming light to pass therethrough may be used instead of the fully reflective mirror. In this case, a through hole may be formed in a lower portion of the mirror of the flywheel, and a shaft of the motor may be a cylindrical hollow shaft. The transmission light which has passed through the half mirror may be caused to reach a position below the motor through the flywheel and the inside of the hollow shaft. In addition, a flywheel and a mirror may be additionally mounted below the motor. The above-described transmission light may be reflected by the mirror in a radial direction (i.e., a second radial direction).

The shapes of details of the respective components may be different from the shapes illustrated in the drawings of the present invention. Features of the above-described preferred embodiments and the modifications thereof may be combined appropriately as long as no conflict arises.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus that rotates while reflecting light emitted from a light source, the rotary drive apparatus comprising:
a motor including a rotating portion rotatable about a central axis extending in a vertical direction;
a flywheel supported by the rotating portion;
a mirror including corner portions and end sides, and having a plate shape; and
adhesives that fix the mirror to the flywheel; wherein
the adhesives are located at the corner portions of the mirror and are spaced apart from one another along the end sides of the mirror.

2. The rotary drive apparatus according to claim 1, wherein each of the adhesives is in contact with both a corresponding one of the corner portions and the flywheel.

3. The rotary drive apparatus according to claim 1, wherein
the flywheel includes a mount surface where the mirror is mounted; and
each of the corner portions of the mirror is sandwiched between the mount surface and a portion of a corresponding one of the adhesives.

4. The rotary drive apparatus according to claim 1, wherein the adhesives are in contact with regions equal to or less than half of the corresponding end sides.

5. The rotary drive apparatus according to claim 1, wherein
the mirror is inclined relative to the central axis; and
some of the adhesives are in contact with corner portions located axially above a center of the mirror among the plurality of corner portions.

6. The rotary drive apparatus according to claim 1, wherein the flywheel includes a mirror accommodating portion in which the mirror is fitted.

7. The rotary drive apparatus according to claim 1, wherein
the mirror has a rectangular plate shape including four corner portions; and
at least the four corner portions are respectively covered with the adhesives.

8. The rotary drive apparatus according to claim 1, wherein each of the adhesives is of an ultraviolet curable adhesive.
